(19) United States
(12) Patent Application Publication
(10) Pub. No.: US 2018/0290299 A1
(43) Pub. Date: Oct. 11, 2018

(54) TEACHING DEVICE, DISPLAY DEVICE, TEACHING PROGRAM, AND DISPLAY PROGRAM

(71) Applicant: LIFE ROBOTICS INC., TOKYO (JP)

(72) Inventors: Masateru KAWAGUCHI, Tokyo (JP); Keiju TERAZONO, Tokyo (JP)

(73) Assignee: LIFE ROBOTICS INC.

(21) Appl. No.: 15/940,466

(22) Filed: Mar. 29, 2018

(30) Foreign Application Priority Data
Apr. 7, 2017 (JP) 2017-77167

(51) Int. Cl. B25J 9/16

(52) U.S. Cl. CPC B25J 9/163; Y10S 901/03

(57) ABSTRACT

A teaching device teaches tasks to a polar robot including an extendable arm supported to be able to turn and vertically rotate, and generates and displays a process chart representing the outline of the tasks of the robot. In the process chart, a plurality of hand task graphic elements each expressed in a form corresponding to a kind of a hand task of the polar robot are disposed along a first axis in an order, each of the hand task graphic elements is disposed along a second axis orthogonal to the first axis in accordance with a height of a hand reference point, each of the hand task graphic elements is rotated in accordance with a turning angle of the arm, and the hand task graphic elements are linked by link lines between the hand task graphic elements, each link line expressing a change in expansion and contraction length of the arm or turning radius of the hand reference point in a form of at least one of changes in hue, chroma, brightness, and line width.

### TECHNICAL FIELD

Embodiments described herein relate to a teaching device, a display device, a teaching program, and a display program.

### BACKGROUND ART

Robot devices have been used in various sites such as production lines and medical or nursing case sites, and are expected to have applications in further fields in the future. In recent years, there has been an increasing expectation for what is called a collaborative Robot, which operates close to a worker, with a prediction saying that the working population will decrease, as a backdrop. The practical application of collaborative Robots allows the prediction that there will be an increase in the number of environments where cooperation robots are manipulated by users who are not specialists of robots and have thus far been less familiar with engineering fields. In general, to operate a robot apparatus, a user needs to teach the robot apparatus beforehand task points and via points to and through which a robot arm is to move, and hand tasks at the task points, which is called teaching. In the teaching, an entering operation of a task point, a via point, and a hand task at the task point, of a robot arm, using an operation pendant, is repeatedly performed in an actual task order of the robot arm.

For users who have thus far been unfamiliar with robots, the teaching operation on a robot using an operation pendant is very cumbersome. This is greatly due to the fact that a user is unable to visually check whether the tasks intended by the user himself or herself have been successfully taught to a robot apparatus before a robot arm is actually operated and the fact that the user is unable to perform the above entering operation while visually checking whether the entering operation has been correctly performed. In addition, there is an operation for choosing a task program to be executed by the robot apparatus from a plurality of task programs, and the operation is also cumbersome for the users who have thus far been unfamiliar with robots. This is due to the fact that, even when every task program is named, a user cannot understand what tasks of a robot arm are defined in a task program until the robot arm is actually operated when many task programs are given similar names, and the fact that it is difficult for a user unfamiliar with a robot to understand what tasks of a robot arm are defined by looking into a task program.

### SUMMARY OF INVENTION

### Technical Problem

A purpose of the present invention is to display tasks to be taught to a robot, in a user-friendly manner.

### Solution to Problem

A teaching device according to the present embodiment teaches tasks to a polar robot including an extendable arm supported to be able to turn and vertically rotate, and generates and displays a process chart representing the outline of the tasks. In the process chart, a plurality of hand task graphic elements each expressed in a form corresponding to a kind of a hand task of the polar robot are disposed along a first axis in an order of the tasks, each of the hand task graphic elements is disposed along a second axis orthogonal to the first axis in accordance with a height of a hand reference point, each of the hand task graphic elements is rotated in accordance with a turning angle of the arm, and the hand task graphic elements are linked by link lines between the hand task graphic elements, each link line expressing a change in expansion and contraction length of the arm or turning radius of the hand reference point in a form of at least one of changes in hue, chroma, brightness, and line width.

### BRIEF DESCRIPTION OF DRAWINGS

FIG. 1 is an external perspective view illustrating the entire robot apparatus including a teaching device according to the present embodiment.

FIG. 2 is a block diagram of the entire robot apparatus including the teaching device according to the present embodiment.

FIG. 3 is a plan view illustrating a teaching screen of the teaching device according to the present embodiment.

FIG. 4 is a diagram illustrating additional buttons in a process chart of FIG. 3.

FIG. 5 is an explanatory diagram illustrating the directions of hand task shape elements in the process chart of FIG. 3.

FIG. 6 is an explanatory diagram illustrating the positions of hand task shape elements in the process chart of FIG. 3.

FIG. 7 is an explanatory diagram illustrating a link line used in the process chart of FIG. 3.

FIG. 8 is a supplementary explanatory diagram for FIG. 7.

FIG. 9 is a diagram illustrating a procedure 1 of a teaching operation using the teaching device according to the present embodiment.

FIG. 10 is a diagram illustrating a procedure 2 of the teaching operation using the teaching device according to the present embodiment.

FIG. 11 is a diagram illustrating a procedure 3 of the teaching operation using the teaching device according to the present embodiment.

FIG. 12 is a diagram illustrating a procedure 4 of the teaching operation using the teaching device according to the present embodiment.

FIG. 13 is a diagram illustrating a procedure 5 of the teaching operation using the teaching device according to the present embodiment.

FIG. 14 is a supplementary explanatory diagram for FIG. 9 to FIG. 13, illustrating a position of a task point.

FIG. 15 is an explanatory diagram illustrating how to edit a process chart illustrated in FIG. 14.

### DESCRIPTION OF EMBODIMENTS

Hereafter, a teaching device 200 according to the present embodiment will be described with reference to the drawings. The teaching device 200 according to the present embodiment is used typically with a connection to a robot apparatus 100 including a polar robot arm mechanism 130. In the following description, the same reference numerals denote components having substantially identical functions and structures, and repeated description thereof is made only when necessary.

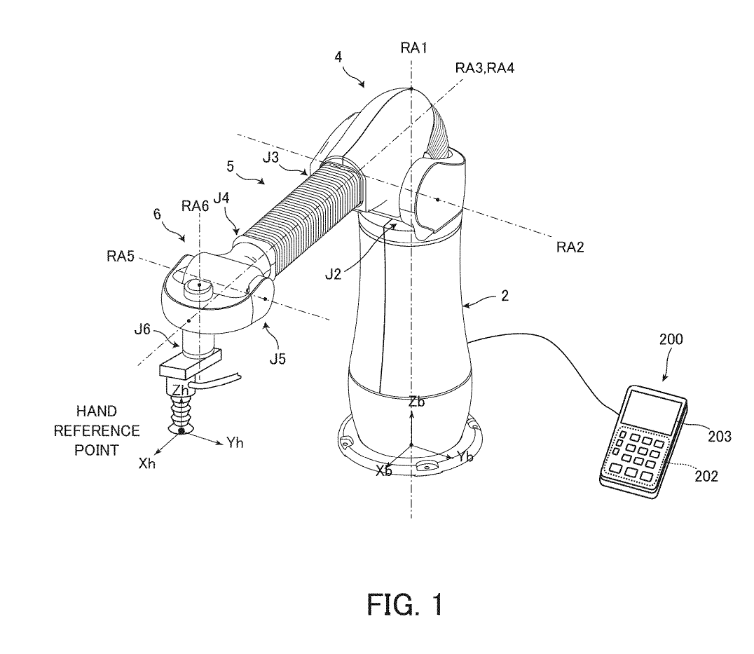

FIG. 1 is a perspective view illustrating the teaching device 200 according to the present embodiment with the robot arm mechanism 130. The teaching device 200 according to the present embodiment is connected to the robot apparatus 100 to be able to communicate with each other. The robot apparatus 100 includes the robot arm mechanism 130. The robot arm mechanism 130 includes a substantially cylindrical support section (base section) 2, a vertically-rotating section 4 mounted in an upper part of the support section 2, an arm section 5 extending from the vertically-rotating section 4, and a wrist section 6 attached to a tip of the arm section 5. In a rotating section of a sixth joint J6 of the wrist section 6, an adapter (not shown) is provided. To this adapter, an end effector 7 is attached.

The robot arm mechanism 130 includes a plurality of (herein, six) joints J1, J2, J3, J4, J5 and J6. The first joint J1, the second joint J2, and the third joint J3 are called root three axes for changing the position of the wrist section 6. The main constituting parts of the first joint J1, the second joint J2, and the third joint J3 are accommodated in the support section 2. The fourth joint J4, the fifth joint J5, and the sixth joint J6 are called wrist three axes for changing mainly the posture of the end effector 7. The main constituting parts of the fourth joint J4, the fifth joint J5, and the sixth joint J6 are accommodated in the wrist section 6.

The first joint J1 is a torsional rotational joint, for turning that includes an axis of rotation RA1 parallel to a vertical direction, and by the rotation of the first joint J1, the arm section 5 makes turn rotations left and right. The second joint J2 is a torsional rotational joint for hoisting that includes an axis of rotation RA2 orthogonal to the axis of rotation RA1, and by the rotation of the second joint J2, the arm section 5 vertically rotates. The third joint J3 is provided by a linear extension and retraction mechanism. The linear extension and retraction mechanism includes a structure that is newly developed by the present inventors and is clearly distinguished from what are conventionally called linear motion joints from the viewpoint of range of movement. The arm section 5 of the third joint J3 extends and retracts along an axis of extension and retraction RA3. As seen from the above, the root three axes are constituted by a torsion joint for turning, a torsion joint for vertically rotating, and a linear extension and retraction mechanism. That is, the robot arm mechanism 130 illustrated in FIG. 1 is of a polar-coordinate type.

The fourth to sixth joints J4 to J6 include axes of rotation RA4 to RA6, respectively, the axes of rotation RA4 to RA6 being orthogonal three axes. The fourth joint J4 is a torsional rotational joint lying about the axis of rotation RA4, which substantially matches the axis of extension and retraction RA3, and by the rotation of the fourth joint J4, the end effector 7 makes swing rotations. The fifth joint J5 is a bending rotational joint lying about the axis of rotation RAS, which is disposed perpendicularly to the axis of rotation RA4, and by the rotation of this fifth joint J5, the end effector 7 makes tilt rotations forward and backward. The sixth joint J6 is a torsional rotational joint lying about the axis of rotation RA6, which is disposed perpendicularly to the axis of rotation RA4 and the axis of rotation RA5, and by the rotation of the sixth joint J6, the end effector 7 makes axial rotations.

As seen from the above, the end effector 7 is moved to a given position by the first joint J1, the second joint J2, and the third joint J3, and placed in a given posture by the fourth joint J4, the fifth joint J5, and the sixth joint J6. In particular, the extension and retraction distance of the arm section 5 of the third joint J3 enables the end effector 7 to reach a wide range from a position close to the support section 2 to a position far from the support section 2. The third joint J3 is characterized in that linear extension and retraction motions realized by the linear extension and retraction mechanism constituting the third joint J3 and the extension and retraction distances of the linear extension and retraction motions are different from those of a conventional linear motion joint.

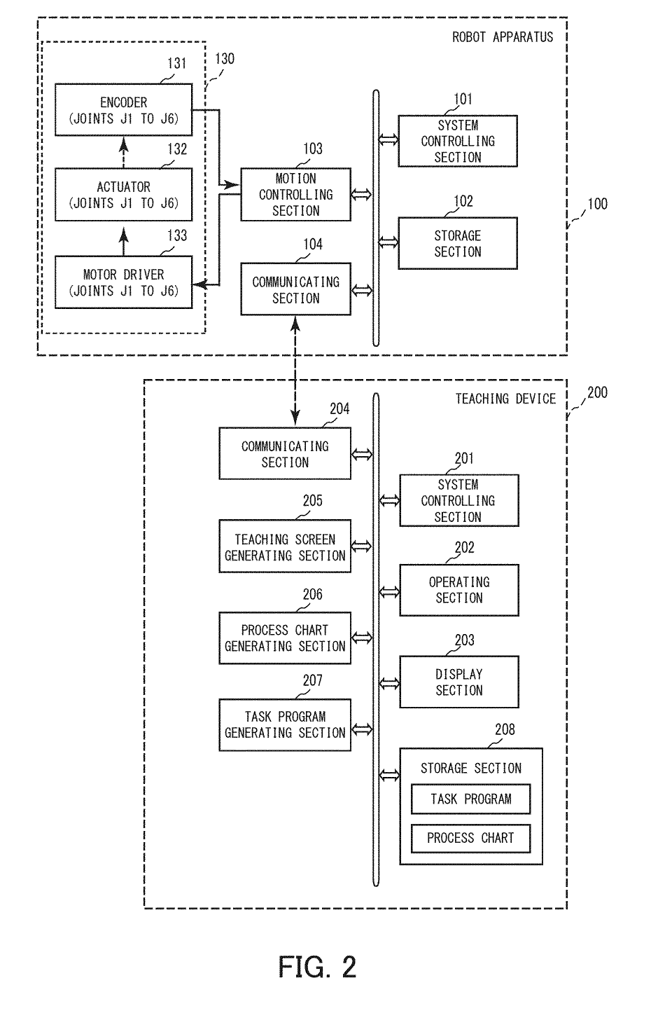

FIG. 2 illustrates the configuration of the entire robot apparatus 100 including the teaching device 200 according to the present embodiment. To the robot apparatus 100, the teaching device 200 is connected to be able to communicate with each other. From the robot apparatus 100 to the teaching device 200, position information on a hand reference point and hand posture information are sent. From the teaching device 200 to the robot apparatus 100, movement information on the hand reference point and a data file of a task program are sent.

### (Robot Apparatus)

Each of the joints of the robot arm mechanism 130 included in the robot apparatus 100 includes an actuator (motor) 132 for driving the joint, a motor driver 133 for controlling the motor 132, and an encoder for measuring a rotation angle of the motor 132. The motor driver 133 supplies the motor 132 with a pulse power corresponding to a command value from a motion controlling section 103, and the motor 132 thereby rotates. The encoder 131 (rotary encoder 131) is attached to a driving shaft of the motor 132 or a rotating shaft of the joint. The encoder 131 detects the rotation angle of the motor 132 and sends data on the detected rotation angle of the motor 132 to the motion controlling section 103.

The robot apparatus 100 includes a communicating section 104, a storage section 108, the motion controlling section 103, and a system controlling section 101. The communicating section 104 communicates various kinds of data to the teaching device 200. The storage section 108 stores a data file for a task program. The system controlling section 101 generally controls the components of the robot apparatus 100. The motion controlling section 103 uses a task program that is read from the storage section 108 to generate joint angles of the respective joints (command values) and sends the generated command values to the motor drivers 133 of the respective joints. In addition, based on movement information on a hand reference point that is received from the teaching device 200, the motion controlling section 103 generates joint angles of the respective joints (command values) and sends the generated command values to the motor drivers 133 of the respective joints. Furthermore, based on the rotation angles of the motors 132 detected by the encoders 131, the motion controlling section 103 calculates joint variables of the respective joints and calculates the position of the hand reference point viewed in a robot coordinate system and the hand posture, using the forward kinematics in accordance with a homogeneous transformation matrix that is specified to correspond to link parameters of the structure of the arm based on the calculated joint variables. For the joints J1, J2, J4, J5, and J6, the joint variable is a positive or negative rotation angle from a reference position, and for the joint J3, the joint variable is an extension distance (linear motion displacement) from a most contracting state.

The hand posture is given in the form of rotation angles about respective orthogonal three axes with respect to a robot coordinate system Σb of a hand coordinate system Σh (a rotation angle a about an Xh axis (yaw angle), a rotation angle β about a Yh axis (pitch angle), and a rotation angle γ about a Zh axis (roll angle)). The robot coordinate system Σb is a coordinate system the origin of which is a given position of the first joint J1 on a first axis of rotation RA1. Of the orthogonal three axes (Xb, Yb, Zb) of the robot coordinate system Σb, the Zb axis is an axis parallel to the first axis of rotation RA1. The Xb axis and the Yb axis are axes orthogonal to each other and orthogonal to the Zb axis. Here, the Xb axis is an axis passing through the center of a movable range of the first joint J1. That is, the Xb axis is an axis parallel to a front-back direction of the base section 2, and the Yb axis is an axis parallel to a widthwise direction (left-right direction) of the base section 2. The hand coordinate system Σh is a coordinate system the origin (hand reference point) of which is the center position of a sucking face of a suction pad attached to the wrist section 6. Of the orthogonal three axes (Xh, Yh, Zh) of the hand coordinate system Σh, the Zh axis is an axis parallel to the sixth axis of rotation RA6. The Xh axis and the Yh axis are axes orthogonal to each other and orthogonal to the Zh axis.

### (Teaching Device)

The teaching device 200 includes a system controlling section 201, an operating section 202, a display section 203, a communicating section 204, a teaching screen generating section 205, a process chart generating section 206, a task program generating section 207, and a storage section 208.

The communicating section 204 communicates various kinds of data to the teaching device 200. The operating section 202 is a pointing device, such as a mouse and a keyboard, for pointing an icon or the like displayed on the display section 203. The display section 203 displays a teaching screen 300 generated by the teaching screen generating section 205 under the control of the system controlling section 201. The storage section 208 stores data for software for teaching the polar robot apparatus 100. This data for the software contains data on a task program having been generated in the past, data on a process chart corresponding to the task program, and the like.

The system controlling section 201 includes a CPU, a ROM, a RAM, and the like. The ROM stores data such as an OS. The RAM functions as a work area or the like for temporarily storing data of a program being executed. The system controlling section 201 reads and executes a program stored in the storage section 208 or the ROM to perform various controls. Specifically, by the system controlling section 201 executing a teaching program for the polar robot apparatus 100 stored in the storage section 208, the functions of the teaching screen generating section 205, the process chart generating section 206, and the task program generating section 207, which will be described later, are implemented. Although the teaching program is described here to be stored in the storage section 208, the teaching program can be downloaded to the storage section 208 via a computer-readable recording medium, such as a CD-ROM and a flexible disk, or can be download using a communication line.

The task program generating section 207 generates data of a task program in accordance with hand tasks input via the operating section 202, and position information of the hand reference point and hand posture information that are received from the robot apparatus 100.

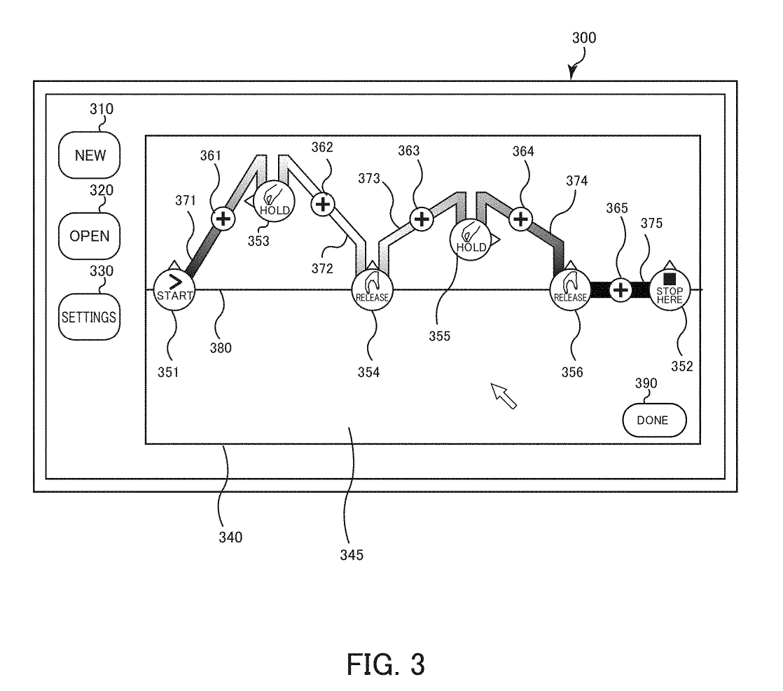

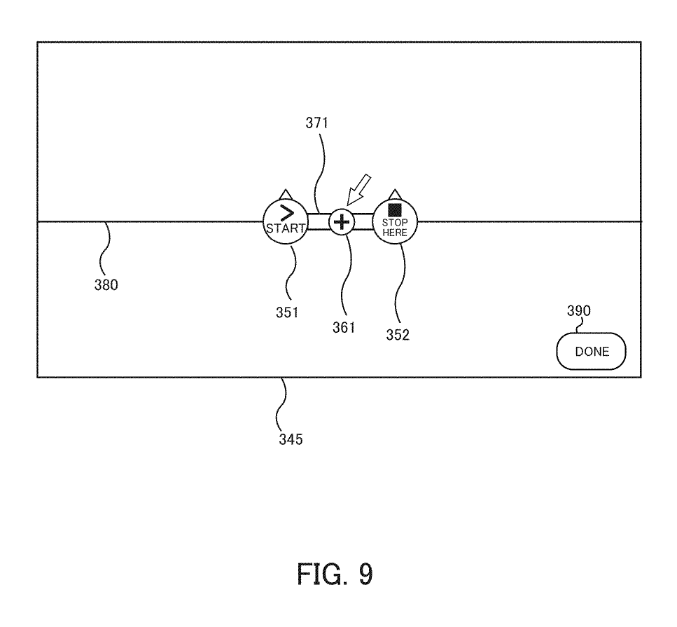

The teaching screen generating section 205 generates data on the teaching screen 300 illustrated in FIG. 3, under the control of the system controlling section 201. The data on the teaching screen 300 generated by the teaching screen generating section 205 is displayed on the display section 203 under the control of the system controlling section 201. FIG. 3 is a plan view illustrating the teaching screen 300 of the teaching device 200 according to the present embodiment. As illustrated in FIG. 3, the teaching screen 300 includes a new button 310, an open button 320, a setting button 330, and a process-chart display region 340. In the process-chart display region 340, a process chart 345 is displayed. The process chart 345 is a chart visually illustrating the outline of tasks of the polar robot including the extendable arm section 5 that is capable of turning and vertically rotating, and is generated by the process chart generating section 206. When the new button 310 is clicked, an initial process chart (FIG. 9) is displayed in the process-chart display region 340. When the open button 320 is clicked, the list of a plurality of task programs stored in the storage section 208 is displayed on a floating window, and a process chart corresponding to the task program that is selected from the plurality of task programs by a user is displayed in the process-chart display region 340. When the setting button 330 is clicked, a setting screen for setting various settings on the process chart is displayed. On the setting screen, the user can make settings on, for example, the initial process chart, an addition of another variation of hand task, and the like.

In the process chart 345, a plurality of graphic elements 351, 352, 353, 354, 355, and 356 are arranged along the horizontal axis 380 (a first axis), the graphic elements 351, 352, 353, 354, 355, and 356 each representing a hand task of the polar robot apparatus 100 in the form corresponding to the kind of the hand task. The graphic elements 353, 354, 355, and 356 are hand task graphic elements each expressed in the form corresponding to the kind of a hand task of the robot. The hand task graphic elements 353 and 355 represent a hand task “hold”, and the hand task graphic elements 354 and 356 represent a hand task “release”. A plurality of hand task graphic elements 353, 354, 355, and 356 are arranged between the graphic element 351 and the graphic element 352 in an order of the robot, the graphic element 351 representing the start of the operation of the robot and the graphic element 352 representing the end of the operation. The hand task graphic elements 353, 354, 355, and 356 are each disposed along a vertical axis (second axis) orthogonal to a horizontal axis 380, in accordance with heights of the hand reference point of the robot when the robot executes the corresponding hand tasks. The hand task graphic elements 353, 354, 355, and 356 are each rotated in accordance with a turning angle of the arm section 5 performing the corresponding hand task. Adjacent graphic elements are linked to each other by a link line. Link lines 371, 372, 373, 374, and 375 each represent a change in an expansion and contraction length of the arm section 5 between hand tasks prior to and subsequent, to the link line or a change in turning radius of the hand reference point, in the form of at least, one of changes in hue, chroma, brightness, and line width. At or near the centers of the link lines 371, 372, 373, 374, and 375, hand task-adding graphic elements 361, 362, 363, 364, and 365 are disposed, respectively.

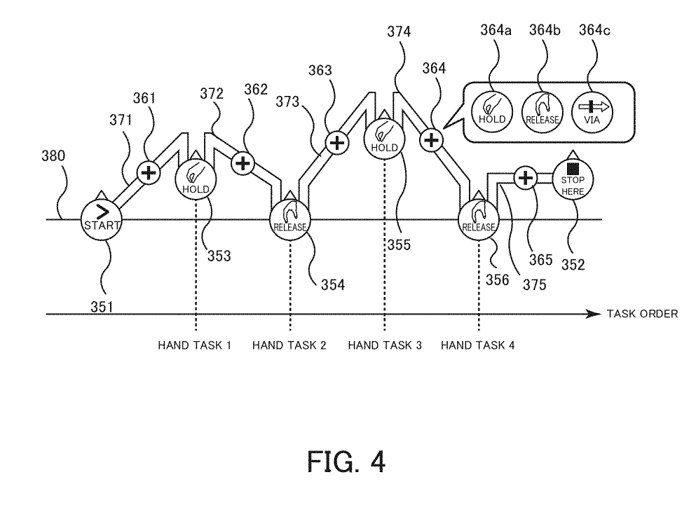

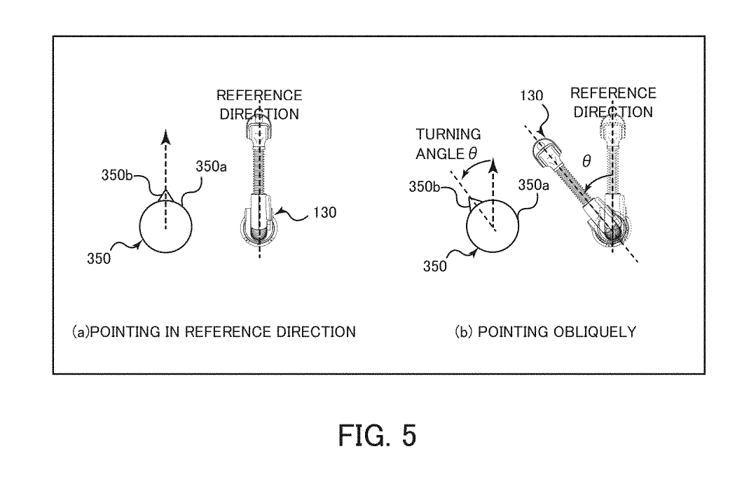

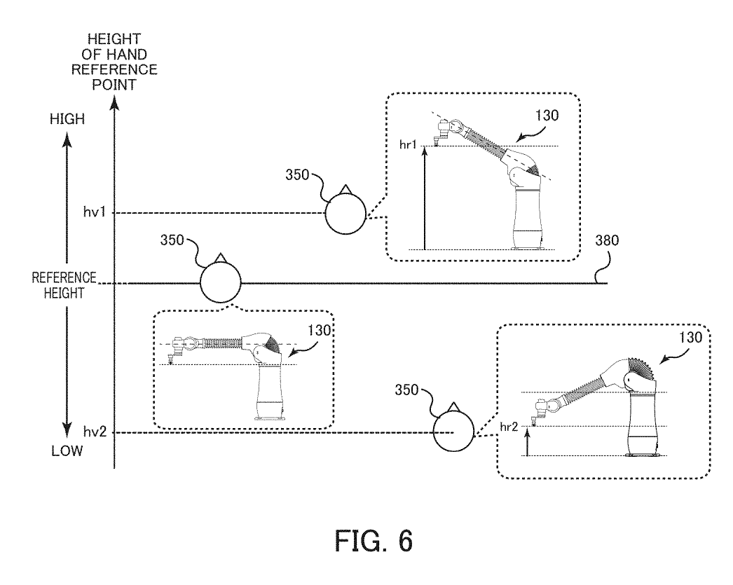

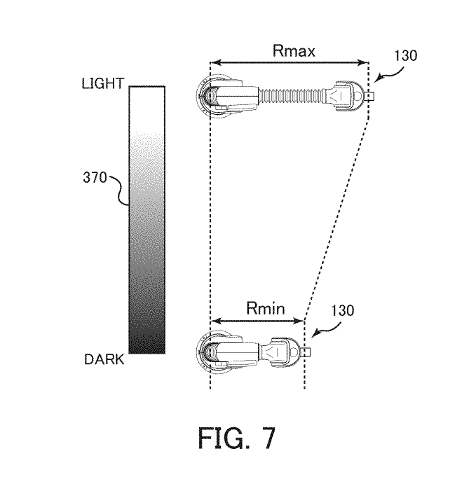

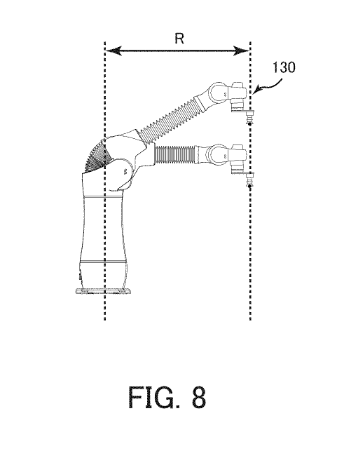

The hand task-adding graphic elements, the hand task graphic elements, and the link lines included in the process chart 345 will be described in detail with reference to FIG. 4 to FIG. 8. FIG. 4, FIG. 5, FIG. 6, and FIG. 7 are explanatory diagrams illustrating the functions of the hand task-adding graphic elements, the directions of the hand task graphic elements, the positions of the hand task graphic elements, and the link lines included in the process chart 345 of FIG. 3, respectively. FIG. 8 is a supplementary explanatory diagram for FIG. 7.

### (Hand Task-Adding Graphic Element)

The process chart generating section 206 rearranges a plurality of graphic elements including a hand task graphic element input by a user along the horizontal axis 380 in an order, and links adjacent hand task graphic elements with link lines. Adding a hand task graphic element by a user can be performed using a hand task-adding graphic element. For example, when a hand task-adding graphic element, is clicked, a plurality of hand task graphic elements are displayed as candidates for the addition of a hand task. From the plurality of hand task graphic elements displayed in the list, the user selects a hand task graphic element corresponding to the hand task to be added. As a result, the hand task graphic element selected by the user is added to an order corresponding to the clicked hand task-adding graphic element. In an example shown in FIG. 4, the hand task-adding graphic element 364 between a hand task 3 and a hand task 4 is clicked, and a hand task graphic element 364a representing a hand task “hold”, a hand task graphic element 364b representing a hand task “release”, and a hand task graphic element 364c representing a via point of the hand are displayed. A hand task graphic element selected from these hand task graphic elements by the user is added as a new hand task 4.

(Description of Hand task Graphic Element: Direction)

The process chart generating section 206 calculates the turning angle of the arm section 5 based on the position information on a hand task point and the posture information on the hand, and rotates the hand task graphic element 350 in accordance with the calculated turning angle of the arm section 5. The hand task graphic element 350 is formed by a circular frame 350a with a triangular protrusion 350b bound on the circumference of a circular frame 350a. In the circular frame 350a, a design and a text representing the kind of a hand task are displayed. The hand task graphic element 350 is modeled on the robot arm mechanism 130 as viewed from above, where the circular frame 350a represents the support section 2, and the protrusion 350b represents the arm section 5. That is, the direction of the protrusion 350b of the hand task graphic element 350 represents the direction of the arm section 5 performing the corresponding hand task. The direction of the protrusion 350b of the hand task graphic element 350 is associated with the actual direction of the arm section 5, for example, as illustrated in FIG. 5(a), the hand task graphic element 350 with the protrusion 350b pointing up indicates that the arm section 5 points a reference direction when performing the corresponding hand task, and the turning angle of that time is defined as 0°. The reference direction of the arm section 5 is a positive direction of the Xb axis of the robot coordinate system, that is, a forward direction of the support section 2 passing through the center of the turning range of the arm section 5. As illustrated in FIG. 5(b), the hand task graphic element 350 with the protrusion 350b pointing a direction inclining from an upward direction toward the left by an angle θ indicates that the arm section 5 points a direction inclining from the reference direction toward the left by the angle θ when performing the corresponding hand task.

### (Description of Hand Task Graphic Element: Position on Vertical Axis)

The process chart generating section 206 calculates the height of the hand reference point based on the position information on the hand task point and the posture information on the hand and disposes the hand task graphic element 350 along the vertical axis in accordance with the calculated height of the hand reference point. The vertical axis of the process chart 345 represents the height of the hand reference point. The lowermost position of the vertical axis is associated with the lowermost position of the actual hand reference point, and the uppermost position of the vertical axis is associated with the uppermost position of the actual hand reference point. For example, the position of the horizontal axis 380 on the vertical axis is associated with the reference position of the hand reference point. The reference position is the height of the hand reference point with respect to the installation surface of the robot arm mechanism 130 when the arm section 5 is in a horizontal posture. Therefore, as illustrated in FIG. 6, the hand task graphic element 350 disposed on the horizontal axis 380 indicates that the arm section 5 is in a horizontal posture when performing the corresponding hand task. The hand task graphic element 350 disposed at a position above the horizontal axis 380 indicates that the hand reference point is disposed to be higher than a reference height, that is, the arm section 5 is in a rising posture above the horizontal posture when the corresponding hand task is performed. A position hv1 of the hand task graphic element 350 on the vertical axis corresponds to a height hr1 of the hand reference point when the corresponding hand task is performed. The hand task graphic element 350 disposed at a position below the horizontal axis 380 indicates that the hand reference point is disposed to be lower than the reference height, that is, the arm section 5 is in a falling posture below the horizontal posture when the corresponding hand task is performed. A position hv2 of the hand task graphic element 350 on the vertical axis corresponds to a height hr2 of the hand reference point when the corresponding hand task is performed.

### (Description of Link Line)

The process chart generating section 206 calculates the expansion and contraction length of the arm section 5 or the turning radius of the hand reference point based on the position information on the hand reference point and the posture information on the hand and changes at least one of the hue, chroma, brightness, or line width of a link line in accordance with the calculated expansion and contraction length of the arm section 5 or the calculated turning radius of the hand reference point. The color of the link line 370 represents the expansion and contraction length of the arm section 5 or the turning radius of the hand reference point. In other words, the color of the link line 370 indicates how far the hand reference point is from the installation position of the robot arm mechanism 130. Here, a change in the turning radius of the hand reference point is represented in the form of a change in the shade of the color of the link line 370. The shade of color is expressed as the combination of brightness and chroma. A turning radius R of the hand reference point is determined by, as illustrated in FIG. 8, the expansion and contraction length of the arm section 5 and the vertical rotation angle of the arm section 5. A maximum turning radius Rmax of the hand reference point is associated with a dark color, and a minimum turning radius Rmin of the hand reference point is associated with a light color. Therefore, a link line is given a color between the dark color for a time of the maximum turning radius Rmax and the light color for a time of the minimum turning radius Rmin, in accordance with the turning radius of the hand reference point. For example, when the color of a link line linking hand task graphic elements prior to and subsequent to the link line has no variations, the link line indicates that the hand reference point is moved from a prior task point to a subsequent task point with its turning radius kept. When the color of a link line linking hand task graphic elements prior to and subsequent to the link line gradually varies to a lighter color as extending from the prior hand task graphic element toward the subsequent hand task graphic element, the link line indicates that the hand reference point is moved from a prior task point to a subsequent task point with its turning radius gradually increased. In a case where a change in the turning radius of the hand reference point is represented in the form of a change in the line width of a link line, when the line width of a link line linking hand task graphic elements prior to and subsequent to the link line gradually varies to a narrower link line as extending from the prior hand task graphic element toward the subsequent hand task graphic element, the link line indicates that the hand reference point is moved from a prior task point to a subsequent task point with its turning radius gradually increased.

### (Teaching Procedure)

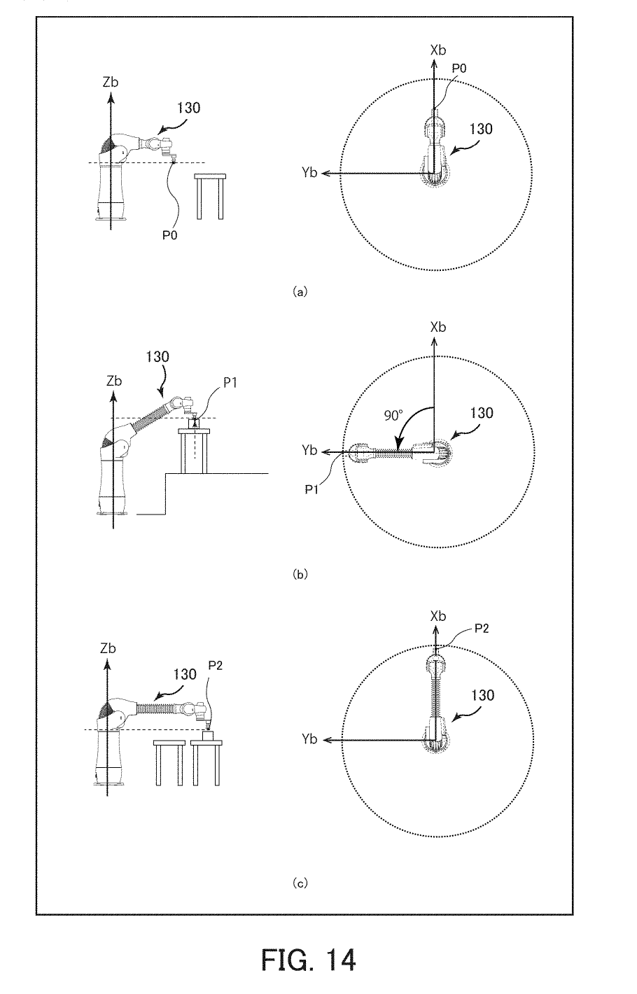

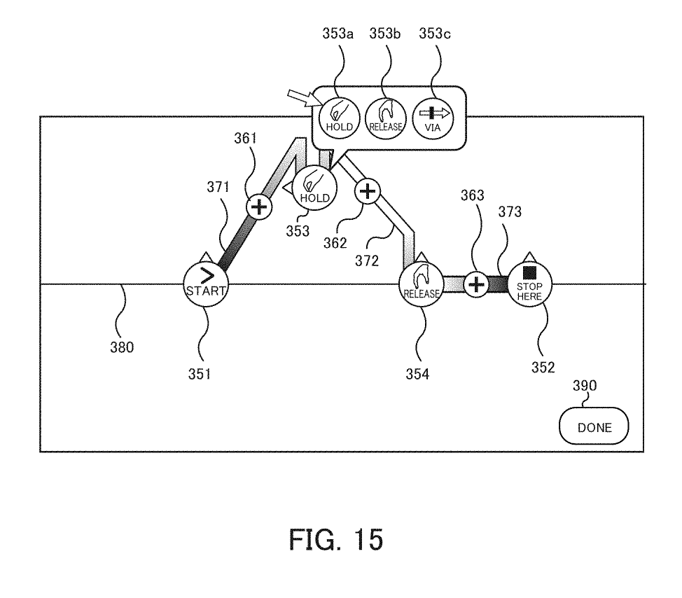

Description will be made about procedures of a teaching operation on a robot using the teaching device 200 according to the present embodiment with reference to FIG. 9 to FIG. 15. FIG. 9 to FIG. 13 are diagrams illustrating, respectively, a procedure 1 to procedure 5 of the teaching operation on the robot using the teaching device 200 according to the present embodiment. The description will be made here about the procedures for teaching the robot a task program about a task including moving from the task starting point P0 to the task point P1, holding a workpiece, moving to the task point P2, releasing the workpiece, and returning to the task starting point P0 as the task ending point. FIG. 14 is a supplementary explanatory diagram for FIG. 9 to FIG. 13. FIG. 14(a), FIG. 14(b), and FIG. 14(c) illustrate the task starting point (task ending point) P0, the task point P1, and the task point P2, respectively. FIG. 15 is an explanatory diagram illustrating how to edit the process chart illustrated in FIG. 14.

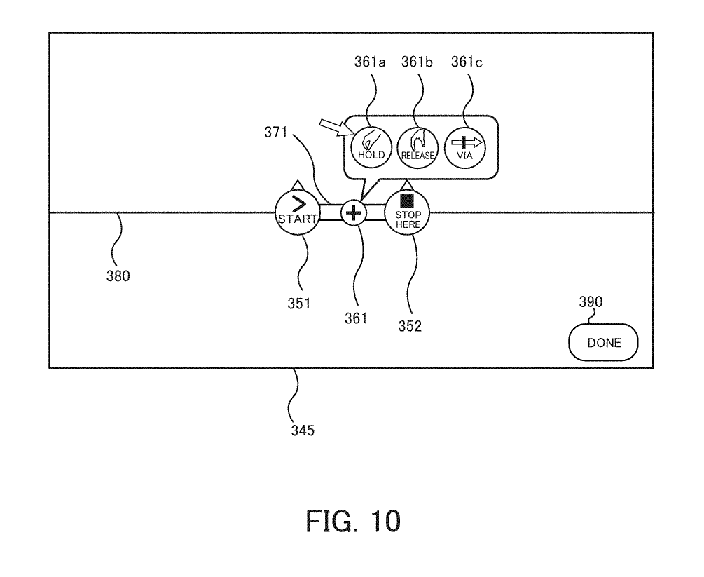

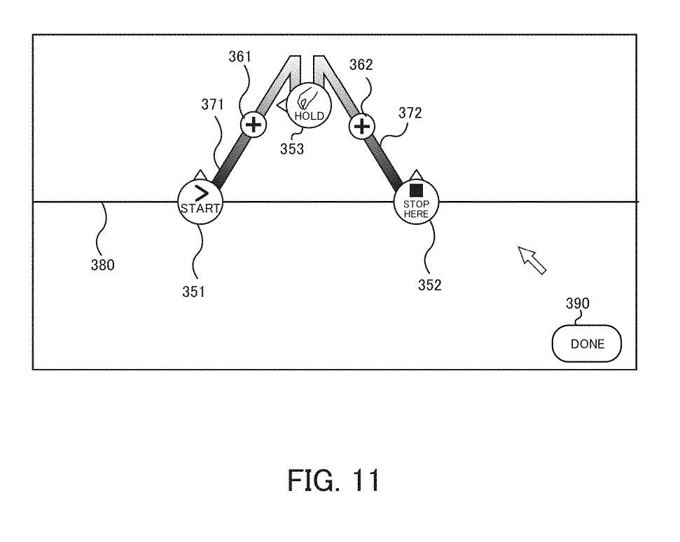

When the new button 310 on the teaching screen 300 is clicked, an initial process chart (FIG. 9) illustrated in FIG. 9 is displayed in the process-chart display region 340. A user moves the arm section 5, using the operating section 202 or directly by hand, to move the hand reference point to the task point P1. Thereafter, as illustrated in FIG. 10, the user selects the hand task-adding graphic element 361, and from a plurality of displayed hand task graphic elements 361a, 361b, and 361c, the user selects the hand task graphic element 361a representing the hand task “hold” to be performed at the task point P1. As a result, the task point P1 of the hand task “hold” is entered, and as illustrated in FIG. 11, the hand task graphic element 353 representing the hand task “hold” is added between the graphic elements 351 and 352. The added hand task graphic element 353 is disposed along the vertical axis in accordance with the height of the task point P1, and the added hand task graphic element 353 is rotated in accordance with the turning angle of the arm section 5. The link line 371 linking the graphic element 351 and the hand task graphic element 353 varies in its color in accordance with the turning radius of the hand reference point calculated based on the position of a task starting point P0 and the position of a task point P1. Similarly, the link line 372 linking the hand task graphic element 353 and the graphic element 352 varies in its color in accordance with the turning radius of the hand reference point calculated based on the position of the task point P1 and the position of a task ending point P0.

As illustrated in FIG. 14, since the task point P1 is at a position higher than the task starting point P0, the hand task graphic element 353 is disposed along the vertical axis at a position above the graphic element 351. The task point P1 is disposed in a direction turning from the reference direction to the left by 90 degrees, and therefore the hand task graphic element 353 is rotated to the left by 90 degrees. With respect to the turning axis of the arm section 5 (Zb axis), the task point P1 is disposed at a position farther than the task starting point P0, and therefore the color of the link line 371 gradually varies to a lighter color from the graphic element 351 toward the hand task graphic element 353. Similarly, with respect to the turning axis of the arm section 5 (Zb axis), the task ending point P0 is disposed at a position closer than the task point P1, and therefore the color of the link line 372 gradually varies to a darker color from the hand task graphic element 353 toward the graphic element 352. The shape of a link line can represent the outline of a trajectory of the hand reference point in a height direction. For example, the link line 371 represents a trajectory in the height direction in which the hand reference point gradually rises from the task starting point P0 toward the task point P1, once disposed at a position above the task point P1, and thereafter falls to the task point P1.

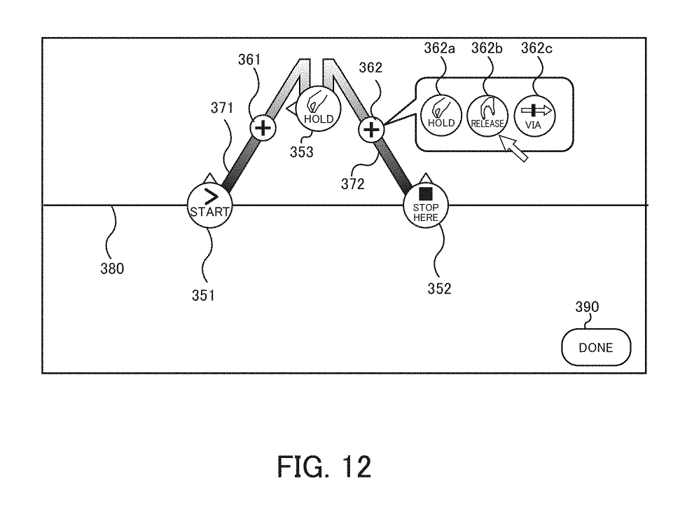

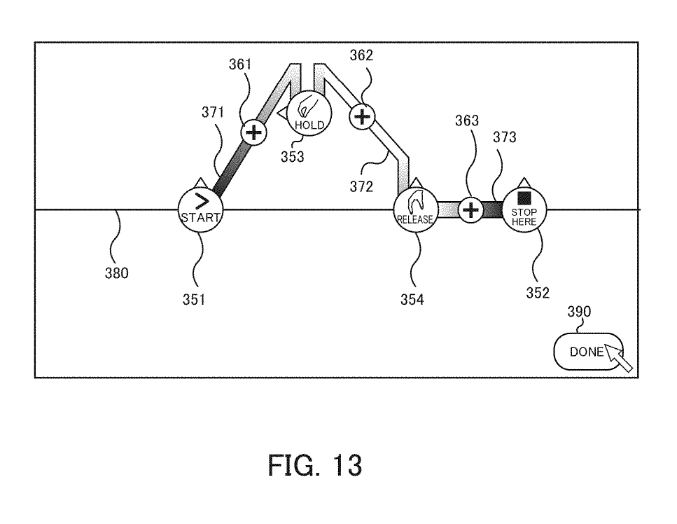

Next, the user moves the arm section 5, using the operating section 202 or directly by hand, to move the hand reference point to the task point P2. Thereafter, as illustrated in FIG. 12, the user selects the hand task-adding graphic element 362 disposed between the hand task graphic element 353 and the graphic element 352, and from a plurality of displayed hand task graphic elements 362a, 362b, and 362c, the user selects the hand task graphic element, 362b representing the hand task “release” performed to be at the task point P2. The task point P2 of the hand task “release” is entered, and as illustrated in FIG. 13, the hand task graphic element 354 representing the hand task “release” is added between the hand task graphic element 353 and the graphic element 352. The added hand task graphic element 354 is disposed along the vertical axis in accordance with the height of the task point P2. In addition, the added hand task graphic element 354 is rotated in accordance with the turning angle of the arm section 5. In addition, the link line 372 linking the hand task graphic element 353 and the hand task graphic element 354 varies in its color in accordance with the turning radius of the hand reference point calculated based on the position of the task point P1 and the position of a task point P2. Similarly, the link line 373 linking the hand task graphic element 354 and the graphic element 352 varies in its color in accordance with the turning radius of the hand reference point calculated based on the position of the task point P2 and the position of the task ending point P0.

As illustrated in FIG. 15, since the task point P2 is at a position lower than the task point P1 and at the same position as the task starting point P0 the hand task graphic element 354 is disposed on the horizontal axis 380. The task point P2 is disposed in the reference direction, the hand task graphic element 354 is not rotated. That is, the hand task graphic element 354 is disposed with its protrusion pointing up. With respect to the turning axis of the arm section 5 (Zb axis), the task point P2 is disposed at the same position as the task point P1, and therefore the color of the link line 372 does not vary from the hand task graphic element 353 toward the hand task graphic element 354. Similarly, with respect to the turning axis of the arm section 5 (Zb axis), the task ending point P0 is disposed at a position closer than the task point P2, and therefore the color of the link line 373 gradually varies to a darker color from the hand task graphic element 354 toward the graphic element 352. The link line 373 represents a trajectory in which the hand reference point moves horizontally from the task point P2 toward the task end point P0.

After completing the entire entering operation of the task points of the hand tasks, the user clicks a done button 390 to complete the teaching operation. Upon the clicking of the done button 390, the task program generating section 207 associates the positions of the hand reference point with hand postures for the hand tasks and generates data on a task program including the positions and hand postures described therein in an order. This data on the task program is associated with the data on the process chart 345 and stored in the storage section 208.

A process chart in teaching and a completed process chart read from the storage section 208 can be edited for changing a hand task, a task point, and the like. As illustrated in FIG. 15, by clicking the hand task graphic element 353, a plurality of hand task graphic elements 353a, and 353b, and 353c are displayed. To change the position of the task point P1, moving the hand reference point to a changed position before selecting the hand task graphic element 353a representing the hand task “hold” suffices. In addition, to change a hand task from “hold” to “release”, moving the hand reference point to a changed position before selecting the hand task graphic element 353b representing the hand task “release” suffices.

With the teaching device 200 according to the present embodiment described above, teaching an operation of a robot can be conducted with a user operation on a process chart. The process chart is a diagram illustrating the outline of the operation of the robot. In conducting the teaching operation using the process chart, every enter of a task point for a hand task causes a hand task graphic element representing the entered hand task to be displayed on the process chart, and in accordance with the position of the entered task point, the position and direction of the hand task graphic element, and the color of a link line are changed. Therefore, looking at the process chart, a user can perform the teaching of an operation of a robot while checking whether an entering operation of task points of hand tasks have been successfully made. In addition, the kind of a hand task graphic element displayed on the process chart allows a user to visually understand what kind of hand task the user has entered. In addition, the position and direction of hand task graphic elements 350 and the colors of link lines 370 displayed on the process chart allow a user to visually understand the positions of task points and outlines of hand trajectories between the task points.

The reason why only the positions and directions of hand task graphic elements 350 and the colors of link lines 370 allow a user to understand the outline of an operation of the robot arm mechanism 130 described in a task program is that the robot arm mechanism 130 developed by the inventors is of a polar-coordinate type with the linear extension and retraction joint J3, which realizes simple robot operations intuitively understood by users. The robot arm mechanism 130 illustrated in FIG. 1 can move the hand reference point (end effector) with the root three axes (the turning joint J1 the vertically-rotating joint J2, and the linear extension and retraction joint J3), and the movable range of the robot arm mechanism 130 is a three-dimensional region defined by implemented possible turning angles of the turning joint J1, implemented possible vertical rotation angle of the vertically-rotating joint J2, and a maximum extension distance of the arm section 5 of the linear extension and retraction joint J3. That is, since the arm section 5 operates within a linear range from the hand to the base section 2, a user can easily predict the positions of task points and hand trajectories from turning angles of the arm section 5, turning radii of the arm section 5, and heights of the hand reference point.

One of the features of the teaching device 200 according to the present embodiment is the choice of three parameters, the turning angle of the arm section 5, the turning radius of the arm section 5, and the height of the hand reference point, from among a plurality of parameters defining the position of the hand reference point of the robot arm mechanism 130, and the visual expression of the three chosen parameters on the process chart.

It is noted that the embodiment is not limited to the teaching device. The teaching device 200 according to the present embodiment can be used as a display device having a function of displaying a process chart corresponding to a task program with the teaching function of the teaching device 200 omitted. Looking at the process chart, displayed on the display device, a user can easily confirm the outline of hand tasks, hand trajectories, and procedures described in the corresponding task program.

While certain embodiments of the present invention have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

### REFERENCE SIGNS LIST

300 . . . teaching screen, 310 . . . new button, 320 . . . open button, 330 . . . setting button, 340 . . . process-chart display region, 345 . . . process chart, 351, 352 . . . graphic element, 353, 354, 355, 356 . . . hand task graphic element, 361, 362, 363, 364, 365 . . . hand task-adding graphic element, 371, 372, 373, 374, 375 . . . link line, 390 . . . done button

1. A teaching device that teaches tasks to a polar robot including an extendable arm supported to be able to turn and vertically rotate, and generates and displays a process chart representing an outline of the tasks, wherein
in the process chart, a plurality of hand task graphic elements each expressed in a form corresponding to a kind of a hand task of the polar robot are disposed along a first axis in an order of the tasks, each of the hand task graphic elements is disposed along a second axis orthogonal to the first axis in accordance with a height of a hand reference point, each of the hand task graphic elements is rotated in accordance with a turning angle of the arm, and the hand task graphic elements are linked by link lines between the hand task graphic elements, each link line expressing a change in expansion and contraction length of the arm or turning radius of the hand reference point in a form of at least one of changes in hue, chroma, brightness, and line width.

2. The teaching device according to claim 1, wherein the hand task graphic elements are arranged along the first axis at regular intervals.

3. The teaching device according to claim 1, wherein a hand task-adding graphic element is disposed at or close to a center of each of the link lines, the hand task-adding graphic element being configured to provide instructions to add a hand task of the polar robot.

4. The teaching device according to claim 1, wherein the hand task graphic elements each include a graphic element representing a holding task of a workpiece and a graphic element representing a releasing task of the workpiece.

5. A teaching device that teaches tasks to an articulated robot, and generates and displays a process chart representing an outline of the tasks, wherein in the process chart, a plurality of hand task graphic elements each expressed in a form corresponding to a kind of a hand task of the articulated robot are disposed along a first axis in an order of the tasks, and each of the hand task graphic elements is disposed along a second axis orthogonal to the first axis in accordance with a height of a hand reference point.

6. A display device comprising:
a storage section for storing; data on a task program for providing instructions of tasks to a polar robot including an extendable arm supported to be able to turn and vertically rotate;
a process chart generating section for generating data on a process chart representing an outline of tasks of the polar robot based on the task program read from the storage section; and
a display section for displaying the process chart, wherein
in the process chart, a plurality of hand task graphic elements each expressed in a form corresponding to a kind of a hand task of the polar robot are disposed along a first axis in an order of the tasks, each of the hand task graphic elements is disposed along a second axis orthogonal to the first axis in accordance with a height of a hand reference point, each of the hand task graphic elements is rotated in accordance with a turning angle of the arm, and the hand task graphic elements are linked by link lines between the hand task graphic elements, each link line expressing a change in expansion and contraction length of the arm or turning radius of the hand reference point in a form of at least one of changes in hue, chroma, brightness, and line width.

7. A display device comprising:
a storage section for storing data on a task program for providing instructions of tasks to an articulated robot;
a process chart generating section for generating data on a process chart representing an outline of tasks of the articulated robot based on the task program read from the storage section; and
a display section for displaying the process chart, wherein
in the process chart, a plurality of hand task graphic elements each expressed in a form corresponding to a kind of a hand task of the articulated robot are disposed along a first axis in an order of the tasks, and each of the hand task graphic elements is disposed along a second axis orthogonal to the first axis in accordance with a height of a hand reference point.

8. A teaching program for providing instructions of tasks to a polar robot including an extendable arm supported to be able to turn and vertically rotate, the teaching program causing a computer to implement:
means for outputting an execution command of an extension/retraction motion, a turning motion, and a vertically rotating motion of the arm to the polar robot according to instructions of a user;
means for inputting a hand task of the polar robot together with a kind of the hand task;
means for generating a process chart representing an outline of the taught tasks; and
means for displaying the generated process chart, wherein the means for generating the process chart disposes a plurality of hand task graphic elements each expressed in a form corresponding to a kind of a hand task of the polar robot along a first axis in an order of the tasks, disposes each of the hand task graphic elements along a second axis orthogonal to the first axis in accordance with a height of a hand reference point, rotates each of the hand task graphic elements in accordance with a turning angle of the arm, and links the hand task graphic elements with link lines between the hand task graphic elements, each link line expressing a change in expansion and contraction length of the arm or turning radius of the hand reference point in a form of at least one of changes in hue, chroma, brightness, and line width.

9. A teaching program for teaching tasks to an articulated robot, the teaching program causing a computer to implement:
means for outputting an execution command of one or more joint tasks to the articulated robot according to instructions of a user;
means for inputting a hand task of the articulated robot together with a kind of the hand task;
means for generating a process chart representing an outline of the taught tasks; and
means for displaying the generated process chart, wherein
the means for generating the process chart disposes a plurality of hand task graphic elements each expressed in a form corresponding to a kind of a hand task of the articulated robot along a first axis in an order of the tasks, and disposes each of the hand task graphic elements along a second axis orthogonal to the first axis in accordance with a height of a hand reference point.

10. A display program causing a computer to implement:
means for reading data on a task program for providing instructions of tasks to a polar robot including an extendable arm supported to be able to turn and vertically rotate, from a storage section;
means for generating a process chart representing an outline of tasks of the polar robot based on the read task program; and
means for displaying the generated process chart, wherein
the means for generating the process chart disposes a plurality of hand task graphic elements each expressed in a form corresponding to a kind of a hand task of the polar robot along a first axis in an order of the tasks, disposes each of the hand task graphic elements along a second axis orthogonal to the first axis in accordance with a height of a hand reference point, rotates each of the hand task graphic elements in accordance with a turning angle of the arm, and links the hand task graphic elements with link lines between the hand task graphic elements, each link line expressing a change in expansion and contraction length of the arm or turning radius of the hand reference point in a form of at least one of changes in hue, chroma, brightness, and line width.

11. A display program causing a computer to implement:
means for reading data on a task program for providing instructions of tasks of an articulated robot from a storage section;
means for generating a process chart representing an outline of tasks of the articulated robot based on the read task program; and
means for displaying the generated process chart, wherein
the means for generating the process chart disposes a plurality of hand task graphic elements each expressed in a form corresponding to a kind of a hand task of the articulated robot along a first axis in an order of the tasks, disposes each of the hand task graphic elements along a second axis orthogonal to the first axis in accordance with a height of a hand reference point.
